(19) United States
(12) Patent Application Publication
(10) Pub. No.: US 2012/0056496 A1
(43) Pub. Date: Mar. 8, 2012

(54) METHOD FOR CONNECTING AN INDUCTIVE LOAD AND CONNECTING CIRCUIT FOR CARRYING OUT THE METHOD

(75) Inventors: Andy RUDEL, Hassloch (DE); Carsten MEINECKE, Karlsruhe (DE); Johann REIS, Biblis (DE)

(73) Assignee: ALSTOM TECHNOLOGY LTD, Baden (CH)

(21) Appl. No.: 13/218,668

(22) Filed: Aug. 26, 2011

(30) Foreign Application Priority Data
Sep. 7, 2010 (DE) 102010044600.9

(51) Int. Cl. H02B 1/24

(52) U.S. Cl. 307/127

(57) ABSTRACT

A method is provided for connecting an inductive load, especially a winding of a generator, for testing purposes to a predetermined alternating medium voltage, whereby the inductive load is connected to the medium voltage by means of a breaker. To reduce the inrush current, the connection is timed to come into effect when the medium voltage has a predetermined phase.

### FIELD OF INVENTION

The present invention relates to the field of electrical power generation. It relates to a method for connecting an inductive load, in particular a winding through the stator bore of a generator, to a predetermined alternating medium voltage. It also relates to a connecting circuit for carrying out the method.

### BACKGROUND

For carrying out high-flux tests on the stator of a generator, a medium voltage of 6-10 kV must be mechanically and electrically connected to a coil or winding consisting of 5-12 windings of a medium-voltage cable which is wound through the stator bore. Up to now, the medium voltage has been connected by closing a conventional medium-voltage breaker from an associated switchboard. The arrangement for this method is shown in principle in FIG. 1. In the testing arrangement 10 of FIG. 1, a winding 13 of a generator 12 can be connected to a medium-voltage switchboard 14 via a connecting circuit 11.

In doing so, extremely high inrush currents can occur due to a transient direct current component in the switching current and the high magnetic remanence of the stator core. This gives rise to serious problems in keeping the circuit breaker closed when the inrush currents exceed the limiting values of the overcurrent trips in the incoming medium-voltage switchboard.

### SUMMARY

The present disclosure is directed to a method for connecting an inductive load of a generator to a predetermined alternating medium voltage. The method includes connecting the inductive load to the medium voltage by a breaker and timing the connection to come into effect when the medium voltage has a predetermined phase, to reduce an inrush current.

The present disclosure is also directed to a connecting circuit for carrying out a method for connecting an inductive load of a generator to a predetermined alternating medium voltage. The method includes connecting the inductive load to the medium voltage by a breaker and timing the connection to come into effect when the medium voltage has a predetermined phase, to reduce an inrush current. The connecting circuit includes medium-voltage connections for connecting the medium voltage; and winding connections for connecting the inductive load which are connected to one another via a breaker. The circuit also includes a first voltage transformer arranged between the medium voltage connections and the breaker. An output of the first voltage transformer is connected to an input of a zero-crossing detector; the zero-crossing detector controls the breaker via a downstream delay circuit.

### BRIEF DESCRIPTION OF THE DRAWINGS

The invention is explained in more detail below with reference to exemplary embodiments in conjunction with the drawing. In the drawing

FIG. 1 shows a greatly simplified schematic diagram of a testing arrangement for high-flux testing on the stator of a generator;

FIG. 2 shows the structure of a connecting circuit for a testing arrangement according to FIG. 1 according to an exemplary embodiment of the invention;

FIG. 3 shows the characteristic with respect to time of the measured voltages before and after the first circuit breaker from FIG. 2;

FIG. 4 shows the switching process according to an exemplary embodiment of the method according to the invention in a voltage-time diagram; and

FIG. 5 shows the flow diagram of the switching process from FIG. 4.

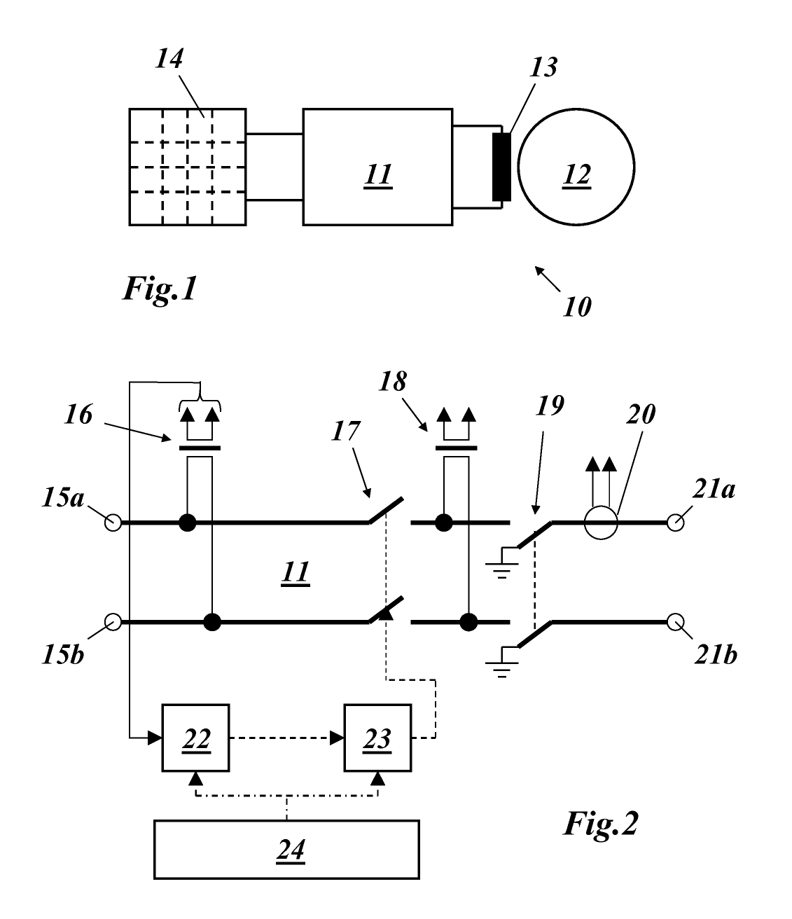

### DETAILED DESCRIPTION OF THE PREFERRED EMBODIMENTS

### Introduction to the Embodiments

The object of the invention is therefore to create a method for connecting such an inductive load to a medium voltage which avoids the disadvantages of known methods and is distinguished by the occurrence of minimal inrush currents, and also to specify a connecting circuit for carrying out the method.

The object is achieved by the appended claims. A preferable feature of the invention is that, to reduce the inrush current, the connection is timed to come into effect when the medium voltage has a predetermined phase.

In an embodiment of the method according to the invention, the connection is timed to come into effect when the medium voltage passes through its phase maximum.

In another embodiment of the method according to the invention, the characteristic of the medium voltage with respect to time is sampled, that it is established when the medium voltage assumes a representative value which is reached a fixed time period before passing through the predetermined phase, and that connection takes place on expiry of the fixed time period.

In particular, the representative value of the medium voltage is a zero-crossing.

Another embodiment is distinguished in that the breaker has its own delay time, and that the fixed time period is chosen to be longer than the delay time of the circuit breaker.

In another embodiment of the method according to the invention, the breaker of a medium-voltage switchboard is used as the breaker.

In another embodiment of the method according to the invention, a medium voltage of 6-10 kV is used.

The connecting circuit according to the invention for carrying out the method has medium-voltage connections for connecting the medium voltage and winding connections for connecting the inductive load which are connected to one another via a breaker, wherein a first voltage transformer is arranged between the medium voltage connections and the breaker, the output of the first voltage transformer is connected to the input of a zero-crossing detector, and the zero-crossing detector controls the breaker via a downstream delay circuit.

In an embodiment of the connecting circuit according to the invention, the delay time of the delay circuit is adjustable.

In another embodiment of the connecting circuit, a control panel is provided, by means of which the zero-crossing detector and the delay circuit can be put into a state of readiness.

### DETAILED DESCRIPTION

The idea on which the invention is based deals with minimizing the inrush currents, which occur while high-flux tests are being carried out, to a first approximation in that the associated breaker which connects the associated winding to the medium-voltage source is closed at the right point of time. In particular, the phase maximum of the alternating voltage of the medium-voltage source is taken to be the right point of time.

The internal structure of a corresponding connecting circuit 11, which is particularly suitable for carrying out the method according to the invention, is reproduced in FIG. 2. On the input side, the connecting circuit 11 has two medium-voltage connections 15a and 15b, to which the medium voltage used, is applied. From the medium-voltage connections 15a and 15b, connecting cables run to two winding connections 21a and 21b, which are located at the output and to which a winding 13 (windings of a medium-voltage cable which is wound through the stator bore) of the generator 12 to be tested is connected. An isolator 19, with the help of which the winding connections 21a and 21b can be disconnected from the supply and grounded, is incorporated in the connecting cables.

A breaker 17, which controls the actual switch-on process, is inserted between the isolator 19 and the medium-voltage connections 15a and 15b. The breaker 17 is controlled according to the characteristics with respect to time of the medium voltage present on the medium-voltage connections 15a and 15b. This alternating voltage is tapped off via a voltage transformer 16 and the output signal of the voltage transformer 16 is fed to a zero-crossing detector 22 which detects the zero-crossings of the alternating voltage and passes on appropriate signals to a delay circuit 23. The time-delayed detector signals are then used to control the breaker 17. In order for one of the time-delayed detector signals to be able to close the breaker 17, the zero-crossing detector 22 and the delay circuit 23 must first be put in a state of readiness by appropriate signals (enable command) from a control panel 24. When this has happened, the next detector signal from the zero-crossing detector 22 is used to switch on the breaker 17 after an appropriate delay in the delay circuit 23.

A further voltage transformer 18 arranged between the breaker 17 and the isolator 19 can be used to monitor the behavior of the output voltage during switch-on. In addition, a current transformer 20 can be used to check the current flowing during the switch-on process.

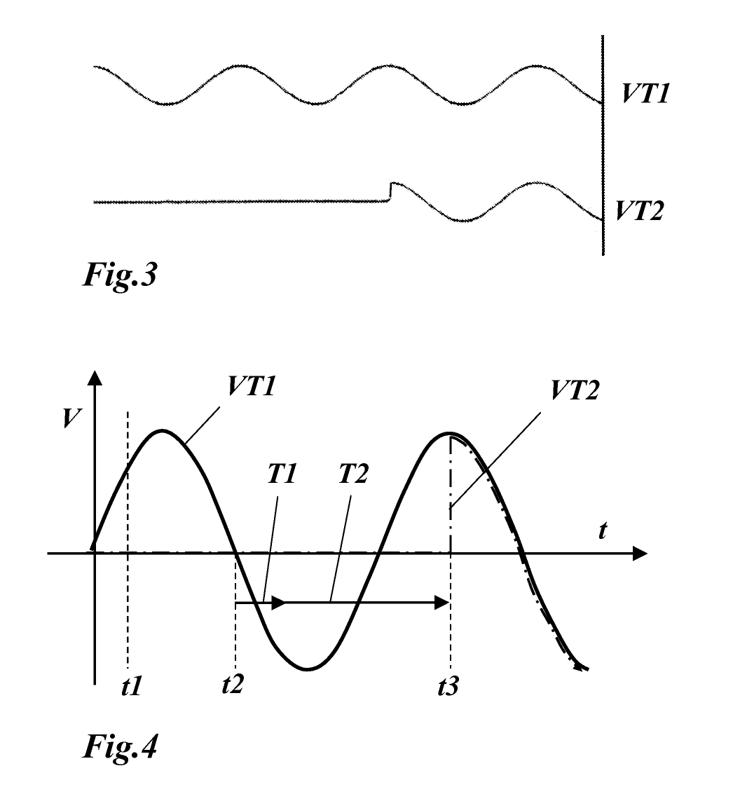

During switch-on, the voltages VT1 and VT2 picked off with the two voltage transformers 16 and 18 have the characteristics with respect to time shown in FIG. 3. Up to the point of switch-on, the transformer voltage VT2 after the breaker 17 is zero, while the voltage (VT1) at the input is applied in full. When the breaker 17 is closed, the transformer voltage VT2 after the breaker 17 jumps to the magnitude of the value corresponding to the currently applied medium voltage and from then on is identical to the transformer voltage VT1.

In a set-up mode, the breaker 17 and the isolator 19 are initially open. The breaker 17 is then closed and, in the process, voltage characteristics of the transformer voltages VT1 and VT2 are simultaneously recorded on an oscilloscope (see FIG. 3). The delay time in the delay circuit 23 is now adjusted so that the total of the set delay time (T1 in FIG. 4) and the inherent delay time of the breaker 17 (T2 in FIG. 4) is just large enough that the alternating voltage appears at the winding connections 21a and 21b when the alternating voltage reaches the phase maximum.

When the delay time has been set, the connecting circuit 11 can be used to carry out the high-flux testing of the generator. For this purpose, the isolator 19 is permanently closed, and at the start of the test (time t1 in FIG. 4) a ready signal is sent from the control panel 24 to the zero-crossing detector 22 and the delay circuit 23. When the next zero-crossing is detected by the zero-crossing detector 22 (time t2 in FIG. 4), the breaker 17 closes after expiry of the set delay time T1 and the inherent delay time T2 (time t3 in FIG. 4), so that from then on the transformer voltage VT2 follows the characteristic of the transformer voltage VT1.

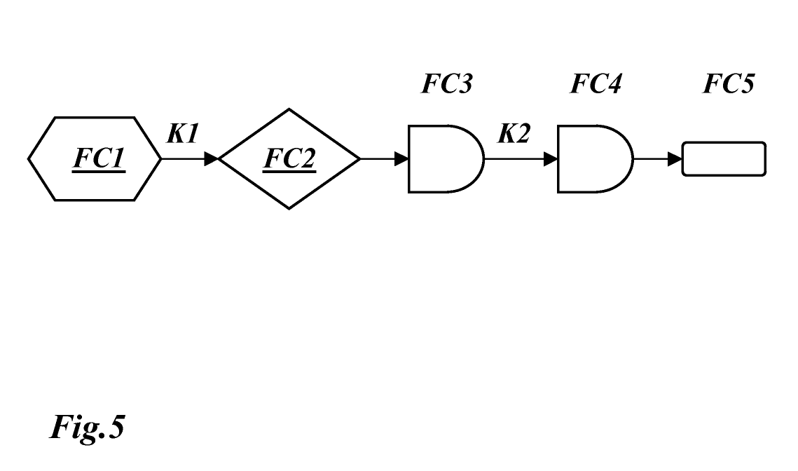

The corresponding flow diagram of this process is shown in FIG. 5. The flow diagram comprises five sections FC1 to FC5. The first section FC1 designates the transition into the active test mode in which the isolator 19 is closed while the breaker 17 is still open. The devices 22 and 23 are then put in a state of readiness with a first command K1. In the second section FC2, the next zero-crossing of the transformer voltage VT1 of the voltage transformer 16 is detected. In the third section FC3, the detector signal is subjected to a first time delay in the circuit 23. The breaker 17 is commanded to switch on with a second command K2. The breaker 17 is actually closed (section FC5) after the inherent delay time of the breaker has expired (section FC4).

### LIST OF REFERENCE SIGNS

10 testing arrangement

11 connecting circuit

12 generator

13 winding (of a medium voltage cable through the stator bore of a generator)

14 medium voltage switchboard

15a,b medium voltage connection

16,18 voltage transformer

17,19 power switch, breaker

20 current transformer

21a,b winding connection

22 zero-crossing detector

23 delay circuit

24 control panel

VT1, VT2 transformer voltage

t1,t2,t3 point-of-time

T1,2 delay time

FC1-FC5 flow chart section

K1,2 command

What is claimed is:

1. A method for connecting an inductive load (13) of a generator (12) to a predetermined alternating medium voltage, the method comprising:
connecting the inductive load (13) to the medium voltage by a breaker (17); and
timing the connection to come into effect when the medium voltage has a predetermined phase, to reduce an inrush current.

2. The method as claimed in claim 1, wherein the connection is timed to come into effect when the medium voltage passes through its phase maximum.

3. The method as claimed in claim 1, wherein a characteristic of the medium voltage with respect to time is sampled, which is established when the medium voltage assumes a representative value which is reached a fixed time period (T1+T2) before passing through the predetermined phase, and the connection takes place on expiry of the fixed time period (T1+T2).

4. The method as claimed in claim 3, wherein the representative value of the medium voltage is a zero-crossing.

5. The method as claimed in claim 3, wherein the breaker (17) has its own delay time (T2), and the fixed time period (T1+T2) is chosen to be longer than the delay time (T2) of the breaker (17).

6. The method as claimed in claim 1, wherein a breaker of a medium-voltage switchboard (14) is used as the breaker (17).

7. The method as claimed in claim 1, wherein a medium voltage of 6-10 kV is used.

8. A connecting circuit (11) for carrying out a method for connecting an inductive load (13) of a generator (12) to a predetermined alternating medium voltage, the method comprising:
connecting the inductive load (13) to the medium voltage by a breaker (17); and
timing the connection to come into effect when the medium voltage has a predetermined phase, to reduce an inrush current, the connecting circuit (11) comprising: medium-voltage connections (15a, 15b) for connecting the medium voltage;
and winding connections (21a, 21b) for connecting the inductive load which are connected to one another via a breaker (17), a first voltage transformer (16) is arranged between the medium voltage connections (15a, 15b) and the breaker (17), an output of the first voltage transformer (16) is connected to an input of a zero-crossing detector (22), the zero-crossing detector (22) controls the breaker (17) via a downstream delay circuit (23).

9. The connecting circuit as claimed in claim 8, wherein the delay time of the delay circuit (23) is adjustable.

10. The connecting circuit as claimed in claim 8, wherein a control panel (24) is provided, by which the zero-crossing detector (22) and the delay circuit (23) can be put into a state of readiness.
